(19) United States
(12) Patent Application Publication
(10) Pub. No.: US 2009/0229155 A1
(43) Pub. Date: Sep. 17, 2009

(54) Information Display Device

(76) Inventor: Ludovic Bertrand, Bonnes (FR)

Correspondence Address: BUCKNAM AND ARCHER, 1077 NORTHERN BOULEVARD, ROSLYN, NY, 11576, US

(21) Appl. No.: 12/226,967

(22) PCT Filed: Apr. 26, 2007
(86) PCT No.: PCT/FR2007/000737

§ 371 Date: Dec. 1, 2008

(30) Foreign Application Priority Data
May 4, 2006 (FR) 06/04016

(51) Int. Cl. G09F 19/22; G09F 7/12

(52) U.S. Cl. 40/594; 40/606.01

(57) ABSTRACT

There is disclosed an information display device, which comprises a ground attachment structure having a convex upper face, and a cooperating convex removable, transparent top cover, between which an information display support is arranged. The structure is hollowed-out on its upper face with channels enabling water to flow towards openings for discharging water to the ground.

This invention relates to the design and construction of an information display device.

The invention relates more specifically to displaying information down on the ground. The device it proposes is particularly appropriate for use outdoors, although it may also be used inside buildings.

In a preferred field of application of the invention, the display device is to be placed in car park areas, at the end of the white lines that delimit the parking spaces. In such cases, the device is used as an information support, but, at the same time, it also has the advantage of ensuring a better delimitation of the spaces.

Meanwhile, the invention does not exclude using the invention device for displaying information on quite different surfaces and, in particular, on vertical wall surfaces or up on ceilings.

The device according to the invention is intended for displaying all types of information, and among them more particularly for displaying signalizing information, such as information entailing commercial indications or information about reserved parking places, or for displaying advertising information.

It is usual to provide for information on the ground by painting the message directly on the ground. This process shows a major disadvantage in the fact that the message painted on the ground is difficult to modify or eliminate. Furthermore, this process is limited in terms of the style of messages that can be displayed, since it is difficult to paint on the ground complex messages, that involve several colors and fine details for example.

Information display devices are know that are designed to be imbedded in the ground with their top part coming flush with the ground surface. They are watertight display casings such as described in patent FR 2 606 540, which have a transparent upper face and inside which a label with the message is placed. Such devices are intended for being installed in hollow cavities formed in the ground in pre-determined locations. They are particularly appropriate for use inside buildings, where cavities for housing the casings are provided during the construction of the building. However, it is very difficult to install such devices in places that have not been equipped therefore beforehand, in particular outdoors, on asphalt road coatings, since in this case, a cavity of the size of the casing must be dug in the ground. This operation is difficult and costly. Furthermore, once the casing has been installed, it is not possible to remove it without having to fill in the cavity.

The invention is intended to overcome the disadvantages of existing ground display systems, and in particular those described above. It proposes an information display device that may be installed easily on any surface, without special preparation of the surface, more particularly outdoors, and that ensures that the information can easily be read as well.

For that purpose, the device according to the invention comprises a ground attachment structure, having a convex upper face and a cooperating convex removable transparent top cover, between which an information label is received. The structure is hollowed-out on its upper face with channels enabling water to flow towards openings for discharging water onto the ground.

Advantageously, the channels are so formed that they manage in the structure raised areas on which the cover abuts in the closed position. These raised areas have respective heights and shape of upper surfaces such, that together, they form a convex supporting surface for the cover.

Such a configuration of the device according to the invention has several advantages.

In particular, through imposing the convex shape of the device to the label placed between the structure and the cover, the legibility of the information printed on the label is increased.

Also, due to this shape little disturbance is encountered on the ground, both for vehicles and for pedestrians.

Furthermore, the cover abutting on the upper face of the raised areas combined with the material making it up, which is advantageously chosen to be both flexible and strong, improves the strength of the whole. On the one hand, the raised areas act as reinforcements for the cover which abuts on them and, on the other, spaces remain between the raised areas enabling the cover to deform vertically without breaking, when pressure is exerted on it. Thanks to this strength and flexibility of deformation, the device according to the invention resists advantageously to the passage over it of vehicles of several tons without breaking.

In addition, the cover is advantageously made of an impact resistant material, so that it is not damaged by impacts, in particular by gravel thrown onto it with force.

The space between the raised areas left by the water-draining channels may advantageously be used as a receptacle for accessories associated with the device, in particular, for an independent back-lighting system for the label.

The device according to the invention is made advantageously so that water entering it (rain water or ground washing water) is spontaneously rejected out of it by the channels, which drain it, in particular with the help of a slight slope, to openings through which it is discharged into the ground. Therefore water which could damage the label does not remain stagnant inside the device.

The fact that the upper face of the device is not fitted with any form of sealing to prevent water entering the device advantageously ensures that condensation due to moisture rising up from the ground does not occur on the inner face of the cover. The legibility of the message on the label is thereby improved.

The device according to the invention therefore advantageously provides for a display of high quality and very good legibility. It may be attached to all types of surfaces, using adhesive or using screws, without the need for any special preparation or fittings. It means not more than a minor hindrance for traffic, thanks to its convex shape and due to its height being preferably quite low and limited for example to a maximum of approximately 20 mm in its central section.

According to the preferred embodiments in industrial practice, the invention also complies with the following characteristics, whether used separately or in each of their technical operative combinations.

In the preferred embodiments of the invention, the raised areas between the water-draining channels are hollowed-out on the lower face of the base structure, so that on the one hand the structure is lighter and cheaper to manufacture and, on the other hand, the device has better flexibility of deformation under the effects of vertical or lateral pressure exerted on it. It is therefore all the stronger.

With the same aim of making the device stronger, according to the invention the raised areas are advantageously connected in pairs by fine cross-linking bars. These links are preferably so dimensioned that they come also into contact with the cover in the closed position, so that they reinforce it still further.

The label used is conventional in itself. It should preferably be plastified, so as to make it more resistant to moisture, or it can be made of thick card when dealing with short-life labels, especially those that should last just a few weeks. All types of messages, in particular the more complex, can be displayed using such labels.

According to a preferred embodiment of the invention, the upper face of the label is coated with a layer of adhesive to enable it to be sticked against the lower face of the cover. The legibility of the label is therefore improved still further, since the entrance of moisture between the label and the cover is avoided.

According to an advantageous characteristic of the invention, the cover is attached to the structure by engaging flexible tabs in cooperating openings made in it. The tabs should be long enough so as to only be disengaged from the corresponding openings under the effects of a strong lateral pressure exerted on either side of the cover and, in particular, so as not to be disengaged by simple manual pressure. The device according to the invention therefore advantageously provides a high level of protection against theft of the label by separating the cover and the structure attached to the ground.

According to another advantageous characteristic of the invention, the upper face of the structure comprises, on the outer edge of each of the openings, a slot allowing for pliers to be inserted to disengage the tabs by applying pressure to the opposing sides of the cover and bringing the tabs towards each other, The cover may therefore be easily separated from the structure, using an appropriate tool, when the label needs to be replaced.

Thus, according to the invention, it is advantageously very simple and easy to attach the cover onto the structure or to separate it from it, using an appropriate instrument, whereas it is impossible to separate them by simple manual operations.

The device according to the invention is advantageously associated with a special tool for use to remove the cover when attached to the structure. The lower end of the tool comprises elongated control rods that can be operated by a user in the standing position and jaws that are operated simultaneously by a single control operation. The jaws are arranged so that they can be inserted simultaneously in all the slots of the structure, one in each, so as to allow the tabs of the cover to be disengaged from their respective cooperating openings.

The cover may therefore be separated from the structure very comfortably by a user in the standing position, without having to crouch or bend. The extended length of the control rods of the jaws also reduces the effort required to exert on the cover a lateral pressure great enough to disengage the tabs from their respective openings.

The same tool can be used advantageously to install a new cover on a structure already fixed on the ground, again by someone in the standing position.

In the preferred embodiments of the invention, the lower face of the structure, covered by the cover in the closed position, has through openings regularly distributed over the entire surface of the channels, which enable to fix it to on the ground using screws or adhesive. These openings are advantageously the same as the openings for discharging water and which are not used attachment to the ground but for discharging water that has entered the device.

When attachment by adhesive is used, a solid attachment resistant to lateral force exerted on the device by the wheels of vehicles passing over it is obtained advantageously due to the fact that the adhesive applied between the lower face of the structure and the ground enters the openings and overflows through them inside the device, thereby forming the equivalent of a particularly effective system of rivets after solidification. The device according to the invention leads thus to excellent holding power when it is attached by adhesive.

According to an advantageous characteristic of the invention and with the same objective of solid attachment to the ground, the structure comprises, on the edge of its lower face intended to be in contact with the ground, radial grooves that improve its adhesion on the ground.

Furthermore, together with the fact that the cover can only be separated from the structure using a special tool, the fact that attachment of the device to the ground is obtained through openings of the base structure that are located under the cover in the closed position, has the advantage of protecting the device against theft once it is installed and fixed on the ground.

Indeed, it is not possible to detach the device from the ground, whether it has been fixed to it by glue or screws, except by first removing the cover to access to the attachment openings and unscrew the attachment screws or destroy the rivets of adhesive using a drill. The device according to the invention therefore provides a high level of security against theft.

A further object of the invention is to ensure good conditions of safety for the users of the device. Accordingly, in the preferred embodiments of the invention, the cover comprises on its upper face an anti-slipping coating and the structure comprises, at the opposing longitudinal ends of its upper face an anti-sticking pattern, so that the risk of pedestrians slipping. or two-wheel vehicles skidding on these parts of the device is avoided.

The device is preferably elongated with a reduce width in the middle, which increases its ergonomics and makes passing over it easier. All its external corners are blunt, so that there is no risk of injury or puncture for users.

In the preferred embodiments of the invention, the cover further comprises on its upper face an anti-scratch coating, which improves the legibility of the label.

The lower face of the cover should be fitted with frames housing the cooperating tabs supported by the outer edge of the label. These frames are evenly spaced along the edge of the cover. This advantageously improves the retention of the label against the surface of the cover. The assembly of the label against the cover is also made easier. Furthermore, and this is highly advantageous from an industrial point of view, the label can be placed in the cover in the factory and the finished assembly can then be transported to the place where the base structure has been attached to the ground to replace a previous cover the label in which has become obsolete.

That results in significant savings in time for the replacement of the label. The replaced cover can then be returned to the factory and be fitted there with the next new label.

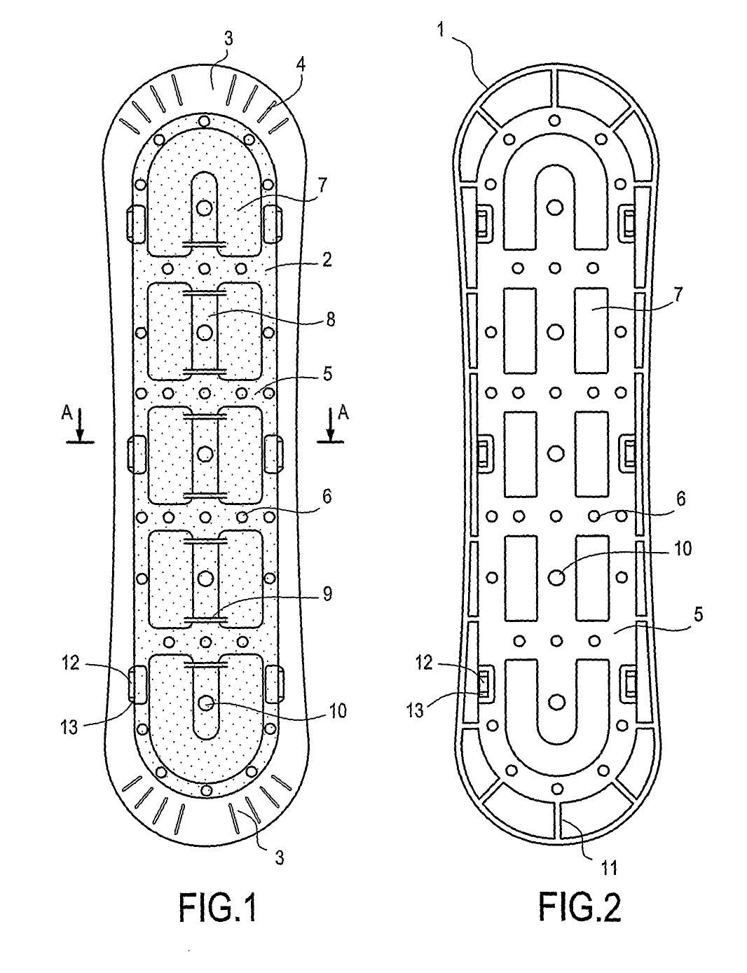

The invention will now be described in greater detail in terms of the preferred characteristics and their advantages, with reference to FIGS. 1 to 5, in which:

FIG. 1 is a top view of a device according to the invention;

FIG. 2 is a view of the underside of the device in FIG. 1;

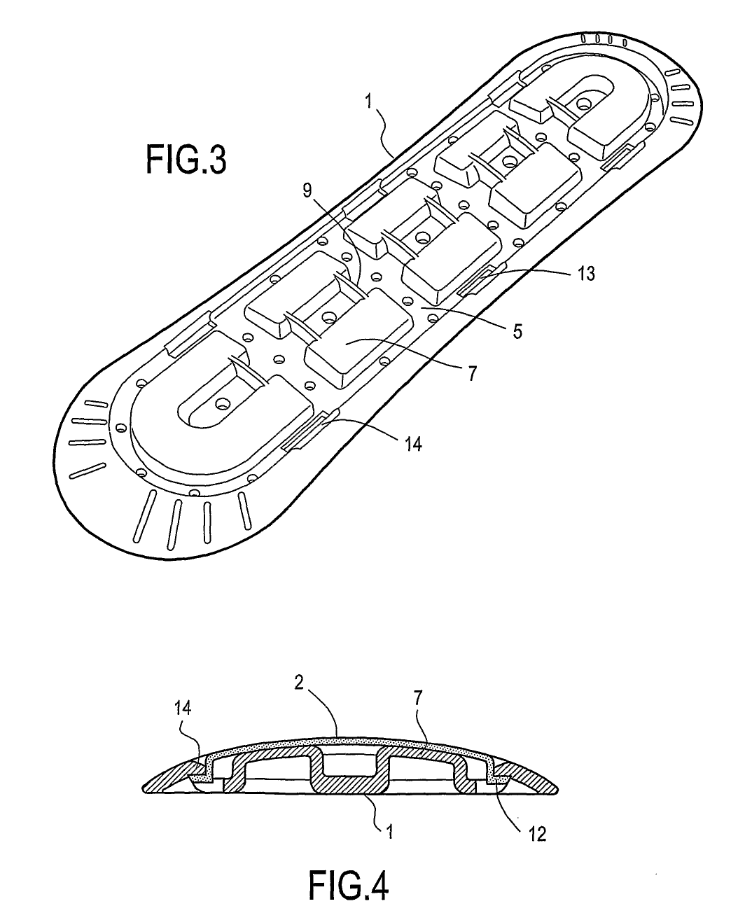

FIG. 3 shows a top view of the ground attachment structure of a device according to the invention in perspective;

FIG. 4 is a cross sectional view of the device in FIG. 1 according to plane A-A;

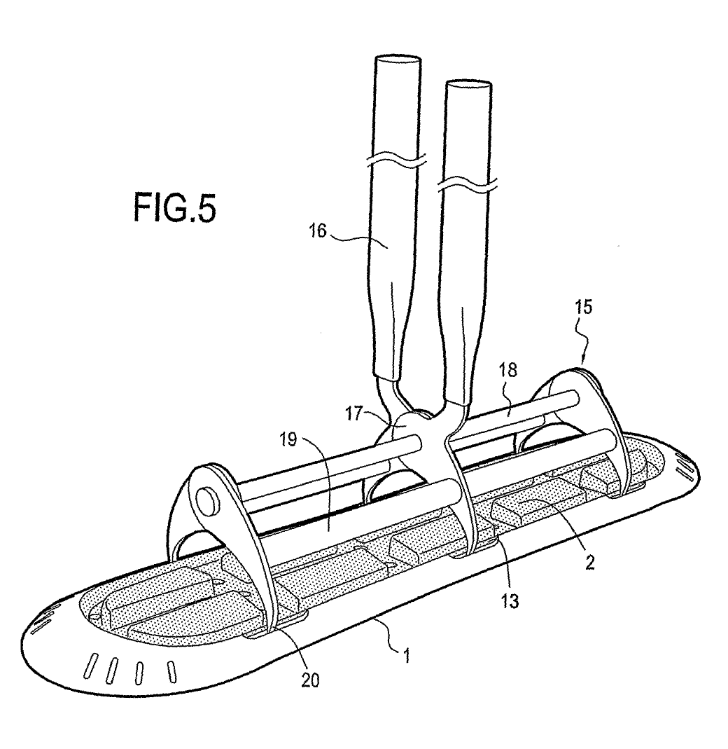

and FIG. 5 is a perspective view of a tool according to the invention mounted on the device in FIG. 1, used to separate the cover and the ground attachment structure.

The device according to the invention comprises a base structure member 1 for its attachment on a receiving ground and a cover member 2 that cooperates with the base structure.

The upper and lower faces of each of these members are herein considered in relation to the normal operating position of the display device, wherein it lies on the ground on the lower face of the base structure 1, with the cover 2 being installed on the upper face of that structure and thus forming the upper face of the full device.

The cover 2 is transparent.

It is attached to the upper face of the base structure 1 so as to cover it almost entirely while being centered on it.

An information panel, or signalization label, which is not shown in the figures for reasons of clarity, is placed between the base structure 1 and the cover 2, with the face on which the information is printed pointing upwards. The panel or label is conventional in itself. Preferably it is coated by a polymer film for long-lasting use outdoors, so as to withstand humidity conditions. The label or panel may also be made of thick card, when the information message it announces is intended to be displayed for only a short period of time. On its upper face carrying the information to be displayed, the label can have an adhesive layer enabling it to be fixed onto the surface of the cover 2. This coating consists, in particular, of a double-side or two-face adhesive tape, one side of which is made to adhere to the label and the other to the cover.

In the absence of a label, the upper face of the base structure 1 is visible through the cover 2, as shown on FIG. 1.

The structure 1 is made of a strong, light material, such as aluminum in particular. As to the cover 2, it is made of a both flexible and impact-resistant polymer material, such as polycarbonate. Its upper face is preferably lined with anti-scratch and anti-slipping coatings.

The base structure 1 and the cover 2 are both convex, as it can be seen from FIG. 4, which shows a cross-sectional view of the device in a plane transverse to it.

Due to that shape upwardly curved in the center that the label shows when it is placed between the base structure 1 and the cover 2, the legibility of the information on the label is increased. In addition the device is easier to cross over, both for the wheels of vehicles and supermarket trolleys and for pedestrians or bicycles.

Furthermore, since the cover 2 rests against the upper face of the base structure 1, it is more resistant to such vertical pressures as may be exerted on it in use.

The device shows a generally elongated form with reduced width in the middle, which again makes it easier to pass over it. The device thickness is virtually zero at its longitudinal edges and it is up to approximately 20 mm in its central cross-section. Its width and length may vary according to each application. They may for example be approximately 15 cm and 50 to 60 cm respectively.

All angles in the device are blunt, and thereby there is no risk of injury for persons passing by and no risk of puncture for the tires of cars or other vehicles.

In its opposed longitudinal end parts 3, which are not covered over by the cover 2, the device base structure 1 is provided with an anti-sticking pattern, comprised of protruding radial corrugations, which reduces the risk of slipping when passing over them.

The upper face of the base structure 1 is hollowed-out with communicating channels distributed over its surface. These channels 5 allow any water that may have filtered into the device at the intersection of the base structure 1 and the cover 2 to flow down to openings 6 pierced through the structure and allow such water to be drained out of the device and discharged onto the ground.

The channels 5 delimit on the structure 1 protruding raised areas 7. They are arranged so as to discharge the water efficiently, wherever it has entered. In the embodiment shown in the figures, a channel 5 extends as a peripheral ring in the bottom of the structure 1 and another one, the central channel 8, is arranged along the longitudinal centre line of the device. These two channels are connected by four transverse channels, as shown in FIG. 3 in particular.

The openings 6 for discharging water are arranged inside the channels 5 at regularly distributed places all over the bottom of the structure.

The upper face of each of the raised areas 7 is inclined towards the longitudinal centre line of the device, so as to form the convex upper face of the structure 1, as may be seen in FIGS. 3 and 4.

The raised areas 7 arranged on either side of the central channel 8 are connected to each another by fine transverse bars 9, which increase the strength of the structure 1. One or two side bars 9 are provided for each pair of raised areas 7 connected to each other.

As shown in FIGS. 4 and 5, the raised areas 7 are hollow, so that the structure 1 be lighter.

The structure 1 may be attached to the ground by adhesive bonding or using screws.

Bonding is carried out by applying a coat of adhesive glue, conventional in itself for this type of application, under the lower face of the structure 1, along the channels 5, and pressing on the lower face of the thus coated device against the receiving ground surface. The adhesive is preferably applied at least along one ring under the peripheral channel 5. The adhesive then enters some of the openings 6 made in the channels 5 and it overflows slightly on the upper face of the structure 1, before setting in this configuration, whereby a strong sticking attachment with high bonding power is obtained.

Openings 10 with a slightly higher diameter are provided for attaching the device to the ground using screws. These openings are preferably arranged along the longitudinal centre line of the device, in the central channel 8, between the pairs of raised areas 7 and the joining bars 9, so as to provide as strong a screw attachment as possible.

The edge of the lower face of the structure 1, appearing on FIG. 2, comprises radial grooves 11 which act in favor of its good adhesion on the ground.

The information label is placed sandwiched between the structure 1 and the cover 2, with its lower face applied on the upper face of the raised areas 7 and its upper face pressed down by the cover 2.

Cover 2 is provided with tabs 12 on its longitudinal edges. In the specific embodiment described here, there are three such tabs 12, that are evenly spaced along each edge. These tabs 12 are intended to be inserted in cooperating openings 13 made in the base structure 1. Attaching the cover 2 on the structure 1 is carried out simply and easily, by engaging the tabs 12 in the openings 13.

A slot 14 is provided on the upper face of the structure 1, on the outer edge of each opening 13, as shown in FIG. 4. These slots 14 are used to seize the cover 2 above each tab 13, using pliers, and by exerting a pressure simultaneously above each pair of opposing tabs urging said tabs together, to disengage the tabs 12 from their respective housings 13, thereby separating the cover 2 from the base structure, to replace the label for example.

The device is associated with a special tool 15 for use to remove the cover 2 from the base structure 1. Said tool is shown on FIG. 5.

It comprises two elongate rods 16, the length of which is sufficient, when the lower end of the tool is placed on the device attached to the ground, to be at the height of the hands of a user in the standing position.

The lower ends of the rods 16 are fitted with three jaws 17, arranged parallel to each other with their gripper arms pointing downwards and hinged on the same shaft 18 perpendicular to the rods 16.

The jaws 17 are also connected on their gripper arms, respectively by the rods 19 parallel to the shaft 18. The rods 16 are connected to the central jaws, so as to open or close the gripping jaws by moving the two rods 16 to and fro with respect to each other, and this movement is transmitted to the two other jaws 17 by the rods 19.

The jaws 17 are distant from each other and so sized that their grasping ends 20 are each inserted simultaneously in respective ones of the slots 14, as shown by FIG. 6, so that the cover 2 is seized above the tabs 12 to disengage them from the openings 13.

The description above clearly explains how the invention can reach the objectives fixed for it. In particular, it provides a device for the display of information on the ground, which may be used easily outdoors and on all types of surfaces, which ensures a display of great quality, with good legibility of the information and which is of no nuisance for users.

Nevertheless, it is clear from the above description that the invention is not limited to the embodiments that have been specifically described and represented in the figures, and on the contrary, it applies to any variant using equivalent means.

The device according to the invention may in particular, be fitted with solar sensors connected to batteries which may be placed in the channels 5, between the raised areas 7. These batteries may supply a system of button lights installed inside of the device, under the label, so as to make it legible in darkness by backlighting and/or a system for broadcasting audio messages also installed between the raised areas 7.

The device may also comprise diodes placed in the openings provided at its ends in particular, so as to provide more effective visual delimitation of parking spaces.

1. An information display device, characterised in that it comprises a base structure (I) for attachment on the ground having a convex upper face and a cooperating transparent, convex, removable upper cover (2) between which a label displaying the information is placed, the said base structure (1) being hollowed-out on its upper face with channels (5) enabling water to flow towards openings (6) for discharging it on the ground.

2. A device according to claim 1, characterised in that said channels (5) delimit in said base structure (1) raised areas (7) on which said cover (2) abuts in the closed position.

3. A device according to claim 2, characterised in that said raised areas (7) are hollowed-out on the lower face of said structure (1).

4. A device according to claim 2, characterised in that said raised areas (7) are connected by pairs by fine side bars (9).

5. A device according to claim 1, characterised in that said cover (2) is attached to said structure (1) by engaging flexible tabs (12) in cooperating openings (13) made on said structure (1) and in that said structure (1) comprises on its upper face, on the outer edge of each of said openings (13), a slot (14) allowing for pliers to be inserted to disengage said tabs by pressure on the opposing sides of said cover (2).

6. A device according to claim 1, characterised in that said structure (1) has on its lower face through openings (6, 10) for its attachment on the ground using screws or by adhesive, which are arranged evenly distributed over the entire surface of said channels (5).

7. A device according to claim 1, characterised in that said structure (I) comprises, on the edge of its lower face intended to be in contact with the ground, radial grooves (11) which improve its adhesion on the ground.

8. A device according to claim 1, characterised in that said cover (2) comprises on its upper face an anti-scratch and anti-slip coating and in that said structure (1) comprises, at the opposing longitudinal ends (3) of its upper face, an anti-sticking pattern (4).

9. A device according to claim 1, characterised in that it has an elongated shape with reduced width in the middle, in that all its external corners are blunt, and in that it is approximately 20 mm thick in its central section.

10. A device according to claim 5, characterised in that it is associated with a special tool (16) for the separation of said cover (2) from said base structure (I) attached to the ground, comprising, at the lower end, extended control rods (16) allowing for the operation, by a user in the standing position, of jaws (17) that may be operated simultaneously by the same control operation and are arranged so as to enable them to be inserted simultaneously respectively in all said slots (14) of said structure (I), so as to disengage said tabs (12) froom said openings (13).
